(19) United States
(12) Patent Application Publication
(10) Pub. No.: US 2025/0026230 A1
(43) Pub. Date: Jan. 23, 2025

(54) PROCESSING APPARATUS AND CONTROL DEVICE

(71) Applicant: SUBARU CORPORATION, Tokyo (JP)

(72) Inventor: Satoru ETO, Tokyo (JP)

(21) Appl. No.: 18/906,518

(22) Filed: Oct. 4, 2024

Related U.S. Application Data
(63) Continuation of application No. PCT/JP2023/025034, filed on Jul. 5, 2023.

(51) Int. Cl. B60L 53/65

(52) U.S. Cl. CPC B60L 53/65

(57) ABSTRACT

A processing apparatus includes one or more processors and one or more memories. The one or more memories are coupled to the one or more processors. The one or more processors are configured to execute a process including acquiring abnormality information that is information relating to a charging abnormality in a charging station where charging of a battery of a vehicle is performed and vehicle information that is information relating to the vehicle in such a manner that the abnormality information and the vehicle information are associated with each other, sequentially accumulating the abnormality information and the vehicle information, which are acquired, in the one or more memories in such a manner that the abnormality information and the vehicle information are associated with each other, and searching for the charging station based on the abnormality information and the vehicle information that have been previously acquired and accumulated.

### CROSS-REFERENCE TO RELATED APPLICATIONS

This application is continuation of International Application No. PCT/JP2023/025034, filed on Jul. 5, 2023, the entire contents of which are hereby incorporated by reference.

### BACKGROUND

The disclosure relates to a processing apparatus and a control device.

There is a vehicle such as an electric vehicle or a hybrid vehicle including a drive motor as a driving source. Such a vehicle is provided with a battery that stores electric power to be supplied to the drive motor. In some cases, a battery of a vehicle can be charged by using a charger of a charging station. In charging using a charger, for example, as disclosed in Japanese Unexamined Patent Application Publication No. 2011-199920, a battery is charged with electric power supplied from the charger in a state where a cable of the charger is coupled to an inlet of the vehicle.

### SUMMARY

An aspect of the disclosure provides a processing apparatus including one or more processors and one or more memories. The one or more memories are coupled to the one or more processors. The one or more processors are configured to execute a process including acquiring abnormality information that is information relating to a charging abnormality in a charging station where charging of a battery of a vehicle is performed and vehicle information that is information relating to the vehicle in such a manner that the abnormality information and the vehicle information are associated with each other, sequentially accumulating the abnormality information and the vehicle information, which are acquired, in the one or more memories in such a manner that the abnormality information and the vehicle information are associated with each other, and searching for the charging station based on the abnormality information and the vehicle information that have been previously acquired and accumulated.

An aspect of the disclosure provides a control device including one or more processors and one or more memories. The one or more memories are coupled to the one or more processors. The one or more processors are configured to execute a process including indicating a result of a search for a charging station conducted based on abnormality information that is information relating to a charging abnormality in the charging station where charging of a battery of a vehicle is performed and that has been previously acquired and accumulated and vehicle information that is information relating to the vehicle and that has been previously acquired and accumulated in such a manner as to be associated with the abnormality information.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating a schematic configuration of a charging system according to an embodiment of the disclosure;

FIG. 2 is a block diagram illustrating an example of a functional configuration of a control device of a vehicle according to the embodiment of the disclosure;

FIG. 3 is a block diagram illustrating an example of a functional configuration of a control device of a charging station according to the embodiment of the disclosure;

FIG. 4 is a block diagram illustrating an example of a functional configuration of a server according to the embodiment of the disclosure;

FIG. 5 is a sequence diagram illustrating an example of a flow of a process that relates to accumulation of various items of information and that is executed in the charging system according to the embodiment of the disclosure; and

FIG. 6 is a sequence diagram illustrating an example of a flow of a process that relates to a search for charging stations and that is executed in the charging system according to the embodiment of the disclosure.

### DETAILED DESCRIPTION

Charging of a battery at a charging station is not always performed properly, and for example, there is a case where a battery cannot be charged. There has been a demand for suppression of occurrence of such a charging abnormality in a charging station.

It is desirable to provide a processing apparatus and a control device capable of suppressing occurrence of a charging abnormality in a charging station.

An embodiment of the disclosure will be described in detail below with reference to the accompanying drawings. Specific dimensions, materials, numerical values, and so forth that are mentioned in the embodiment are merely examples for ease of understanding of the disclosure and do not limit the disclosure unless otherwise specified. Note that, in the present specification and the drawings, elements that have substantially the same functions and configurations are denoted by the same reference signs to omit repeated descriptions thereof, and elements that do not directly relate to the disclosure are not illustrated.

### <Configuration of Charging System>

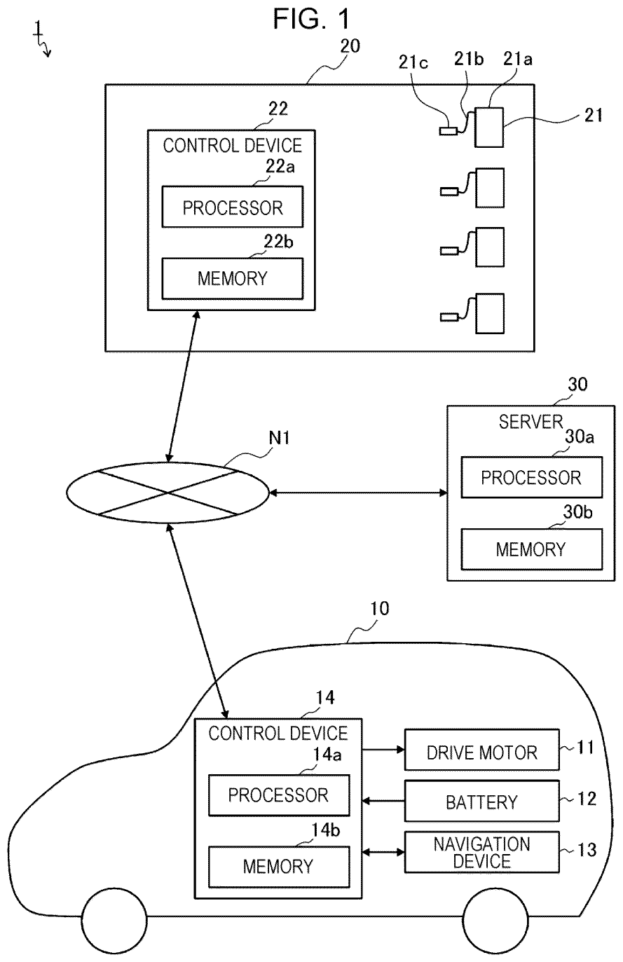

A configuration of a charging system 1 according to the embodiment of the disclosure will be described with reference to FIG. 1 to FIG. 4.

FIG. 1 is a schematic diagram illustrating the schematic configuration of the charging system 1. As illustrated in FIG. 1, the charging system 1 includes a vehicle 10, a charging station 20, and a server 30. The vehicle 10, the charging station 20, and the server 30 can communicate with each other via a wireless communication network Ni. The server 30 corresponds to an example of a processing apparatus according to the disclosure.

Note that, although the single vehicle 10 is illustrated in FIG. 1 for ease of understanding, the charging system 1 actually includes a plurality of the vehicles 10. In addition, although the single charging station 20 is illustrated in FIG. 1 for ease of understanding, the charging system 1 actually includes a plurality of the charging stations 20.

As illustrated in FIG. 1, the vehicle 10 includes a drive motor 11, a battery 12, a navigation device 13, and a control device 14. For example, the vehicle 10 is an electric vehicle that includes the drive motor 11 as a driving source. However, the vehicle 10 may be a hybrid vehicle that includes an engine as a driving source in addition to the drive motor 11.

The drive motor 11 outputs power to be transmitted to wheels of the vehicle 10 and is, for example, a three-phase alternating-current motor. The drive motor 11 is driven by electric power of the battery 12 so as to output the power.

The battery 12 can charge and discharge electric power. As the battery 12, for example, a lithium ion battery, a lithium ion polymer battery, a nickel-metal hydride battery, a nickel-cadmium battery, or a lead-acid battery is used. However, a battery different from these may be used. The battery 12 stores electric power to be supplied to the drive motor 11.

The navigation device 13 is a device that provides a driving route from a current location of the vehicle 10 to a destination desired by a driver who drives the vehicle 10 in response to an input operation performed by the driver. The navigation device 13 has a function of visually displaying information and displays various items of information relating to providing a route. Examples of the items of information displayed by the navigation device 13 include the current location of the vehicle 10, a driving route to be provided, the position of a destination, the distance from the current location of the vehicle 10 to the destination on the driving route, an arrival time to the destination, and so forth. The navigation device 13 can acquire information indicating the current location of the vehicle 10 based on a signal transmitted from a global positioning system (GPS) satellite.

In addition, the navigation device 13 displays the positions of various facilities. For example, the navigation device 13 superimposes and displays the various facilities on a map. The driver of the vehicle 10 can set a facility that the driver desires as a destination by selecting the various facilities on the map. In particular, the navigation device 13 can display the position of the charging stations 20.

The control device 14 includes one or more processors 14a and one or more memories 14b coupled to the one or more processors 14a. The one or more processors 14a include, for example, a central processing unit (CPU). The one or more memories 14b include, for example, a read only memory (ROM), a random access memory (RAN), and the like. The ROM is a memory device that stores programs, operation parameters, and the like used by the CPU. The RAM is a memory device that temporarily stores data such as variables, parameters, and the like used for processing that is performed by the CPU.

The control device 14 communicates with each device included in the vehicle 10. Communication between the control device 14 and each device is performed by using, for example, controller area network (CAN) communication.

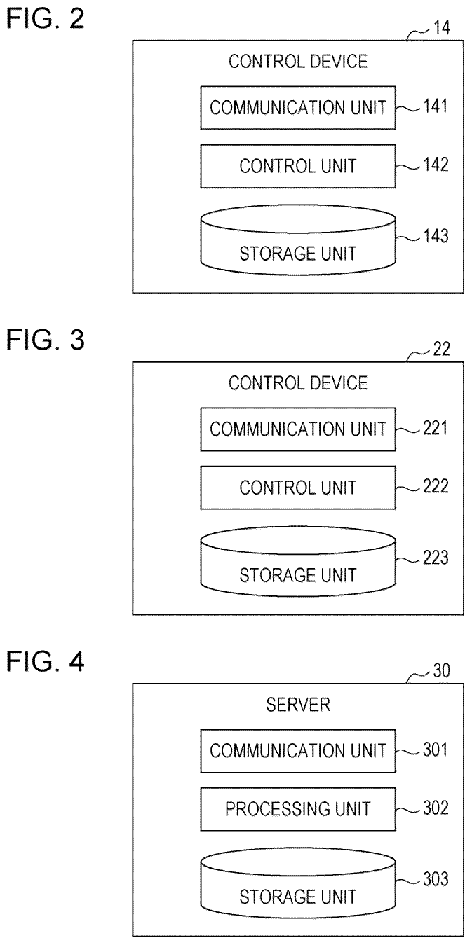

FIG. 2 is a block diagram illustrating an example of a functional configuration of the control device 14 of the vehicle 10. For example, as illustrated in FIG. 2, the control device 14 includes a communication unit 141, a control unit 142, and a storage unit 143.

Note that various processing operations including processing operations that are performed by the communication unit 141 or the control unit 142 and that will be described below may be performed by the one or more processors 14a. More specifically, the one or more processors 14a run the programs stored in the one or more memories 14b, thereby performing the various processing operations. The function of the storage unit 143 is realized by the one or more memories 14b. However, the functions of the control device 14 may be divided among a plurality of devices, and the functions of the control device 14 may be realized by a single device.

The communication unit 141 communicates with the charging stations 20 and the server 30 via the communication network Ni.

The control unit 142 performs various processing operations for controlling the operation of each device in the vehicle 10. For example, the control unit 142 controls the operation of the drive motor 11. For example, the control unit 142 acquires various items of information such as a remaining capacity from the battery 12. For example, the control unit 142 controls the operation of the navigation device 13.

The storage unit 143 stores various items of information. The information stored in the storage unit 143 is used in the processing operations performed by the communication unit 141 or the control unit 142. For example, the communication unit 141 transmits the information stored in the storage unit 143. For example, the control unit 142 controls the operation of each device in the vehicle 10 by using the information stored in the storage unit 143.

As illustrated in FIG. 1, the charging station 20 includes a plurality of chargers 21 and a control device 22. The battery 12 of the vehicle 10 is charged at the charging station 20.

The chargers 21 are each a device for charging the battery 12 of the vehicle 10. Each of the chargers 21 includes a main body 21a, a charging cable 21b, and a charging gun 21c. The main body 21a is installed in the charging station 20 and receives electric power supplied from a power supply source (not illustrated). The charging gun 21c is coupled to the main body 21a by the charging cable 21b. When the charging gun 21c is attached to an inlet of the vehicle 10, the charging cable 21b is electrically coupled to the inlet of the vehicle 10. In this state, electric power can be supplied from the main body 21a to the battery 12 of the vehicle 10 via the charging cable 21b. As a result, the battery 12 is charged.

The control device 22 includes one or more processors 22a and one or more memories 22b coupled to the one or more processors 22a. The one or more processors 22a include, for example, a CPU. The one or more memories 22b include, for example, a ROM, a RAM, and the like.

FIG. 3 is a block diagram illustrating an example of a functional configuration of the control device 22 of the charging station 20. For example, as illustrated in FIG. 3, the control device 22 includes a communication unit 221, a control unit 222, and a storage unit 223.

Note that various processing operations including the processing operations that are performed by the communication unit 221 or the control unit 222 and that will be described below may be performed by the one or more processors 22a. More specifically, the one or more processors 22a run the programs stored in the one or more memories 22b, thereby performing the various processing operations. The function of the storage unit 223 is realized by the one or more memories 22b. However, the functions of the control device 22 may be divided among a plurality of devices, and the functions of the control device 22 may be realized by a single device.

The communication unit 221 communicates with the vehicles 10 and the server 30 via the communication network Ni.

The control unit 222 performs various processing operations for controlling the operation of each device included in the charging station 20. For example, the control unit 222 controls the operations of the chargers 21.

The storage unit 223 stores various items of information. The information stored in the storage unit 223 is used in the processing operations performed by the communication unit 221 or the control unit 222. For example, the communication unit 221 transmits information stored in the storage unit 223. For example, the control unit 222 controls the operation of each device in the charging station 20 by using the information stored in the storage unit 223.

As illustrated in FIG. 1, the server 30 includes one or more processors 30a and one or more memories 30b coupled to the one or more processors 30a. The one or more processors 30a include, for example, a CPU. The one or more memories 30b include, for example, a ROM, a RAM, and the like.

FIG. 4 is a block diagram illustrating an example of a functional configuration of the server 30. For example, as illustrated in FIG. 4, the server 30 includes a communication unit 301, a processing unit 302, and a storage unit 303.

Note that various processing operations including processing operations that are performed by the communication unit 301 or the processing unit 302 and that will be described below may be performed by the one or more processors 30a. More specifically, the one or more processors 30a run the programs stored in the one or more memories 30b, thereby performing the various processing operations. The function of the storage unit 303 is realized by the one or more memories 30b. However, the functions of the server 30 may be divided among a plurality of devices, and the functions of the server 30 may be realized by a single device.

The communication unit 301 communicates with the vehicles 10 and the charging stations 20 via the communication network Ni.

The processing unit 302 performs various processing operations. In particular, as will be described later, the processing unit 302 can search for the charging stations 20.

The storage unit 303 stores various items of information. The information stored in the storage unit 303 is used in the processing operations performed by the communication unit 301 or the processing unit 302. For example, the communication unit 301 transmits information stored in the storage unit 303. For example, the processing unit 302 searches for the charging stations 20 by using the information stored in the storage unit 303.

### <Operation of Charging System>

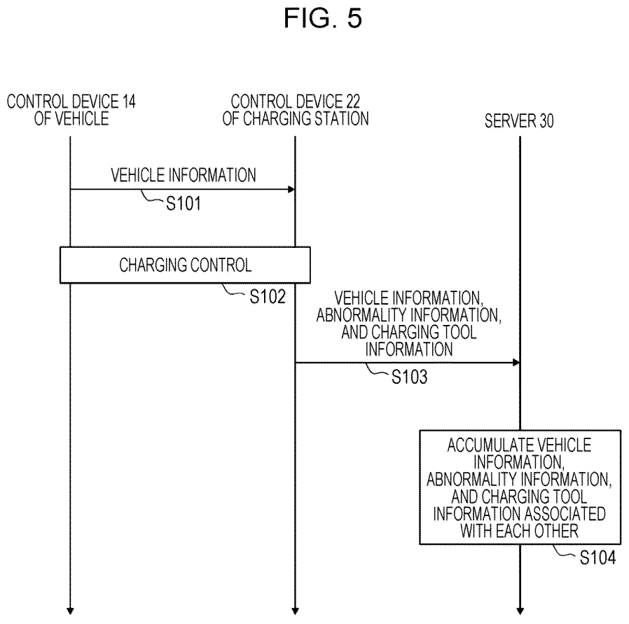

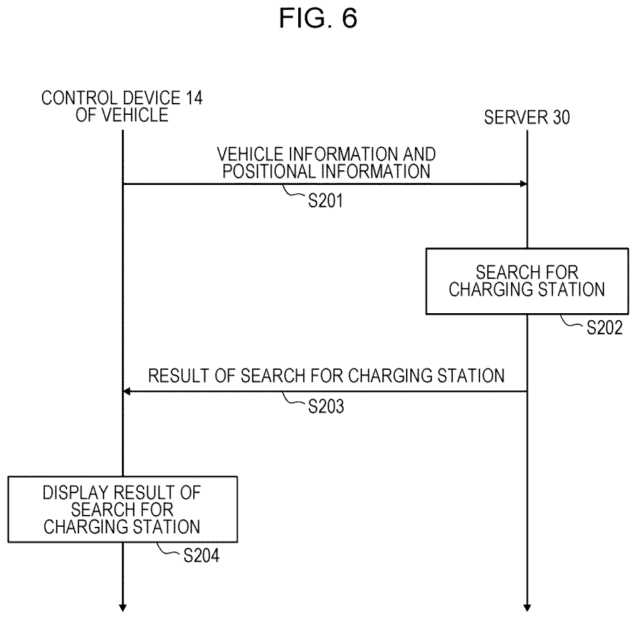

Operation of the charging system 1 according to the embodiment of the disclosure will now be described with reference to FIG. 5 and FIG. 6.

As described above, the battery 12 of the vehicle 10 is charged at the charging station 20. Here, charging of the battery 12 at the charging station 20 is not always performed properly, and for example, there is a case where the battery 12 cannot be charged. In the charging system 1 according to the present embodiment, by devising the search for the charging stations 20 that is conducted by the server 30, suppression of occurrence of charging abnormalities in the charging stations 20 is achieved.

In the charging system 1, various items of information are accumulated beforehand in the server 30, and a search for the charging stations 20 is conducted by using the various items of information. A process relating to accumulation of the various items of information will be described below with reference to FIG. 5, after which a process relating to a search for the charging stations 20 will be described with reference to FIG. 6.

FIG. 5 is a sequence diagram illustrating an example of a flow of a process that relates to accumulation of the various items of information and that is executed in the charging system 1.

The process illustrated in FIG. 5 is executed in a situation where the battery 12 of the vehicle 10 is charged at one of the charging stations 20. More specifically, the process illustrated in FIG. 5 is started when one of the charging guns 21c is attached to the inlet of the vehicle 10 and the corresponding charging cable 21b is coupled to the inlet of the vehicle 10.

In the process example illustrated in FIG. 5, when the charging cable 21b is coupled to the inlet of the vehicle 10, first, in step S101, the communication unit 141 of the control device 14 of the vehicle 10 transmits vehicle information to the communication unit 221 of the control device 22 of the charging station 20. Then, the communication unit 221 of the control device 22 of the charging station 20 receives the vehicle information. The vehicle information received by the communication unit 221 is stored in, for example, the storage unit 223.

The vehicle information is information relating to the vehicle 10 and may include various items of information. The vehicle information is stored beforehand in, for example, the storage unit 143 of the control device 14.

For example, the vehicle information may include information relating to the type of the vehicle 10. Examples of such information include information indicating the automobile model name of the vehicle 10, information indicating the model number of the vehicle 10, and the like.

In addition, for example, the vehicle information may include information relating to the battery 12. Examples of such information include information indicating the name of the battery 12, information indicating the model number of the battery 12, and the like.

Furthermore, for example, the vehicle information may include information relating to software used in the vehicle 10 for charging. Examples of such information include information indicating the name of the software used in the vehicle 10 for charging, information indicating the version of the software used in the vehicle 10 for charging, and the like.

Note that the vehicle information is not limited to the above-mentioned examples. For example, the vehicle information may include information relating to the state of the vehicle 10 or the state of the battery 12. Examples of such information include information indicating the degree of degradation of the battery 12.

Note that, in step S101, the communication unit 141 may transmit a plurality of items of vehicle information. For example, the communication unit 141 may transmit a plurality of any of the items of vehicle information mentioned above as examples.

Next, in step S102, the control unit 142 of the control device 14 of the vehicle 10 and the control unit 222 of the control device 22 of the charging station 20 perform charging control. The charging control is control for charging the battery 12 with one of the chargers 21. For example, in the charging control, the battery 12 is charged at a preset charging speed until the remaining capacity of the battery 12 reaches a predetermined target remaining capacity.

Next, in step S103, the communication unit 221 of the control device 22 of the charging station 20 transmits the vehicle information, abnormality information, and charging tool information to the communication unit 301 of the server 30. Then, the communication unit 301 of the server 30 receives the vehicle information, the abnormality information, and the charging tool information.

The abnormality information is information relating to a charging abnormality in the charging station 20 and may include various items of information. For example, the control device 22 acquires, from the charger 21 used for charging of the battery 12, information indicating a result of the charging, and the control device 22 acquires the abnormality information based on the acquired information. Examples of information indicating the result of the charging include information indicating the progression of the remaining capacity of the battery 12 and the like.

For example, the abnormality information may include information indicating the occurrence or nonoccurrence of a charging abnormality. Examples of such information include information indicating that a charging abnormality has occurred and information indicating that no charging abnormality has occurred.

In addition, for example, the abnormality information may include information indicating the contents of a charging abnormality. Here, examples of the charging abnormality include an abnormality caused by communication, an abnormality caused by an electrical factor, an abnormality caused by a mechanical factor, and the like. The abnormality information indicating the contents of the charging abnormality is, for example, information indicating which type of abnormality among the above-mentioned abnormalities has occurred.

An example of the abnormality caused by communication includes an abnormality in which charging is not performed properly due to a problem in the communication between the vehicle 10 and the charger 21. An example of the abnormality caused by an electrical factor includes an abnormality in which charging is not performed properly due to a problem in an electrical circuit formed between the vehicle 10 and the charger 21. An example of the abnormality caused by a mechanical factor includes an abnormality in which charging is not performed properly due to a problem relating to the coupling between the inlet of the vehicle 10 and the charging gun 21c of the charger 21.

Note that the contents of the charging abnormality are not limited to the above-mentioned examples. For example, in the charging station 20, charging of the battery 12 may not be performed due to a problem in payment for a charging fee. Examples of the problem in payment for a charging fee include an authentication error with a credit card and the like. The contents of the charging abnormality may also include such contents.

Note that the abnormality information is not limited to the above-mentioned examples. For example, the abnormality information may include information indicating in which charger 21 among the plurality of chargers 21 of the charging station 20 the charging abnormality has occurred.

Note that, in step S103, the communication unit 221 may transmit a plurality of items of abnormality information. For example, the communication unit 221 may transmit a plurality of any of the items of abnormality information mentioned above as examples.

The charging tool information is information relating to a charging tool that is used in the charging station 20 for charging, and the charging tool information may include various items of information. The charging tool information is stored beforehand in, for example, the storage unit 223 of the control device 22.

For example, the charging tool information may include information relating to software used in the charging station 20 for charging. Examples of such information include information indicating the name of the software used in the charging station 20 for charging, information indicating the version of the software used in the charging station 20 for charging, and the like.

In addition, for example, the charging tool information may include information relating to a device that is used in the charging station 20 for charging. Examples of such information include information indicating the type of the charger 21, information indicating the state of the charger 21, and the like. An example of the information indicating the state of the charger 21 includes information indicating whether a malfunction has occurred in the charger 21.

Note that, in step S103, the communication unit 221 may transmit a plurality of items of charging tool information. For example, the communication unit 221 may transmit a plurality of any of the items of charging tool information mentioned above as examples.

In step S103, which has been described above, the communication unit 301 of the server 30 acquires the vehicle information, the abnormality information, and the charging tool information such that they are associated with each other. Next, in step S104, the processing unit 302 of the server 30 stores and accumulates the vehicle information, the abnormality information, and the charging tool information associated with each other in the storage unit 303. Then, the process flow illustrated in FIG. 5 ends.

As described above, the server 30 acquires the vehicle information, the abnormality information, and the charging tool information such that they are associated with each other. Accordingly, the vehicle information, the abnormality information, and the charging tool information are accumulated in the server 30 while they are associated with each other. Thus, the server 30 can determine the charging station 20 and the vehicle 10 where a charging abnormality has occurred in the past. In addition, the server 30 can also determine the contents of the charging abnormality that has occurred in the past. Furthermore, the server 30 can determine the charging tool used when the charging abnormality occurred.

FIG. 6 is a sequence diagram illustrating an example of a flow of a process that relates to a search for the charging stations 20 and that is executed in the charging system 1.

The process illustrated in FIG. 6 is executed when the driver of the vehicle 10 requests a search for the charging stations 20. More specifically, the driver of the vehicle 10 can transmit a command for requesting a search for the charging stations 20 to the server 30 via the communication unit 141 of the control device 14. The process illustrated in FIG. 6 starts when such a command is transmitted to the server 30.

In the process example of FIG. 6, once a command for requesting a search for the charging stations 20 has been transmitted to the server 30, first, in step S201, the communication unit 141 of the control device 14 of the vehicle 10 transmits, together with the above-mentioned command, the vehicle information and positional information to the communication unit 301 of the server 30. Then, the communication unit 301 of the server 30 receives the vehicle information and the positional information.

The positional information is information indicating the current position of the vehicle 10. For example, the control device 14 of the vehicle 10 acquires the positional information from the navigation device 13.

Next, in step S202, the processing unit 302 of the server 30 searches for the charging stations 20.

In step S202, the processing unit 302 searches for the charging stations 20 that are located within a predetermined distance from the current position of the vehicle 10 on the basis of the positional information of the vehicle 10 acquired in step S201.

Here, in step S202, the processing unit 302 searches for the charging stations 20 by using the vehicle information acquired in step S201 and the information accumulated in the storage unit 303 of the server 30. As mentioned above, the vehicle information, the abnormality information, and the charging tool information are accumulated in the server 30 such that they are associated with each other.

More specifically, in the search for the charging stations 20, the processing unit 302 extracts the charging station 20 where it is presumed that a charging abnormality is highly likely to occur during charging of the battery 12 of the vehicle 10 that has requested the search for the charging stations 20. The vehicle 10 that requests the search for the charging stations 20 will hereinafter be also referred to as a target vehicle. In addition, the charging station 20 where it is presumed that a charging abnormality is highly likely to occur during charging of the battery 12 of the vehicle 10 that requests the search for the charging stations 20 will hereinafter be also referred to as the charging station 20 where a charging abnormality is presumed to occur.

For example, the processing unit 302 extracts the charging station 20 where a charging abnormality has occurred in the past during charging of the battery 12 of the vehicle 10 that corresponds to the vehicle information of the target vehicle as the charging station 20 where a charging abnormality is presumed to occur.

For example, the processing unit 302 extracts the charging station 20 where a charging abnormality has occurred in the past during charging of the battery 12 of the vehicle 10 whose automobile model name or model number is the same as that of the target vehicle as the charging station 20 where a charging abnormality is presumed to occur.

For example, the processing unit 302 extracts the charging station 20 where a charging abnormality has occurred in the past during charging of the battery 12 whose name or model number is the same as that of the battery 12 of the target vehicle as the charging station 20 where a charging abnormality is presumed to occur.

For example, the processing unit 302 extracts the charging station 20 where a charging abnormality has occurred in the past during charging of the battery 12 of the vehicle 10 that uses software with the same name or the same version as the software of the target vehicle as the charging station 20 where a charging abnormality is presumed to occur.

In the above description, the case in which the processing unit 302 searches for the charging stations 20 on the basis of the vehicle information and the abnormality information, which indicates the occurrence or nonoccurrence of a charging abnormality, has been described. However, the processing unit 302 may search for the charging stations 20 by taking other information into consideration.

For example, the processing unit 302 may search for the charging stations 20 by taking into consideration abnormality information indicating the contents of a charging abnormality. In the charging station 20 where a charging abnormality has occurred in the past during charging of the battery 12 of the vehicle 10 that corresponds to the vehicle information of the target vehicle, depending on the contents of the charging abnormality occurred in the past, there may be a case where it is not presumed that a charging abnormality is highly likely to occur during charging of the battery 12 of the target vehicle. Thus, for example, the processing unit 302 may exclude, in accordance with the contents of charging abnormalities occurred in the past, some of the charging stations 20 where a charging abnormality has occurred in the past during charging of the battery 12 of the vehicle 10 that corresponds to the vehicle information of the target vehicle from the charging stations 20 where a charging abnormality is presumed to occur.

For example, in the case where the charging abnormality occurred in the past is an abnormality caused by communication and where it is determined that the abnormality will not occur with the software of the target vehicle, the processing unit 302 may exclude the charging station 20 where the abnormality has occurred in the past from the charging stations 20 where a charging abnormality is presumed to occur. For example, in the case where the charging abnormality occurred in the past is an abnormality caused by an electrical factor and where it is determined that the abnormality will not occur with the configuration of the electric circuit of the target vehicle, the processing unit 302 may exclude the charging station 20 where the abnormality has occurred in the past from the charging stations 20 where a charging abnormality is presumed to occur. For example, in the case where the charging abnormality occurred in the past is an abnormality caused by a mechanical factor and where it is determined that the abnormality will not occur with the configuration of the inlet of the target vehicle, the processing unit 302 may exclude the charging station 20 where the abnormality has occurred in the past from the charging stations 20 where a charging abnormality is presumed to occur. For example, in the case where the charging abnormality occurred in the past is an abnormality due to a problem in payment for a charging fee, the processing unit 302 may exclude the charging station 20 where the abnormality has occurred in the past from the charging stations 20 where a charging abnormality is presumed to occur.

For example, the processing unit 302 may search for the charging stations 20 by taking the charging tool information into consideration. In the charging station 20 where a charging abnormality has occurred in the past during charging of the battery 12 of the vehicle 10 that corresponds to the vehicle information of the target vehicle, in the case where the charging tool information acquired when the charging abnormality has occurred in the past is different from the current charging tool information, there may be a case where it is not presumed that a charging abnormality is highly likely to occur during charging of the battery 12 of the target vehicle. Thus, for example, the processing unit 302 may exclude, in accordance with a result of a comparison between the charging tool information acquired when the charging abnormality has occurred in the past and the current charging tool information, some of the charging stations 20 where a charging abnormality has occurred in the past during charging of the battery 12 of the vehicle 10 that corresponds to the vehicle information of the target vehicle from the charging stations 20 where a charging abnormality is presumed to occur.

For example, in the case where the name or the version of the software used for charging in the charging station 20 when a charging abnormality has occurred in the past is different from the current name or the current version of the software, the processing unit 302 may exclude the charging station 20 from the charging stations 20 where a charging abnormality is presumed to occur. For example, in the case where the type or the state of the charger 21 used for charging in the charging station 20 when a charging abnormality has occurred in the past is different from the current type or the current state of the charger 21, the processing unit 302 may exclude the charging station 20 from the charging stations 20 where a charging abnormality is presumed to occur.

For example, the processing unit 302 may search for the charging stations 20 by taking into consideration the abnormality information indicating in which charger 21 among the plurality of chargers 21 in the charging station 20 a charging abnormality has occurred. For example, the processing unit 302 may exclude, in accordance with the number of the chargers 21 in which a charging abnormality has occurred, some of the charging stations 20 where a charging abnormality has occurred in the past during charging of the battery 12 of the vehicle 10 that corresponds to the vehicle information of the target vehicle from the charging stations 20 where a charging abnormality is presumed to occur. For example, in one of the charging stations 20, in the case where a charging abnormality has occurred in the past in only some of the chargers 21 and has not occurred in some of the other chargers 21, the processing unit 302 may exclude the charging station 20 from the charging stations 20 where a charging abnormality is presumed to occur.

Next, in step S203, the communication unit 301 of the server 30 transmits a result of the search for the charging stations 20 conducted in step S202 to the communication unit 141 of the control device 14 in the vehicle 10. Then, the communication unit 141 of the control device 14 of the vehicle 10 receives the result of the search for the charging stations 20.

Next, in step S204, the control unit 142 of the control device 14 in the vehicle 10 causes the navigation device 13 to display the result of the search for the charging stations 20. As a result, the driver of the vehicle 10 can use the result of the search for the charging stations 20 so as to designate one of the charging stations 20 as a place the vehicle 10 is headed to. For example, the driver of the vehicle 10 sets the charging station 20, which has been designated as the place the vehicle 10 is headed to, as a destination and causes the navigation device 13 to provide a driving route. Then, the process flow illustrated in FIG. 6 ends.

In step S204, for example, the control unit 142 causes the navigation device 13 to display the charging stations 20 that are located within a predetermined distance from the current position of the vehicle 10 excluding the charging station 20 where a charging abnormality is presumed to occur. However, the control unit 142 may cause the navigation device 13 to display the charging station 20 where a charging abnormality is presumed to occur in a manner different from a manner in which the other charging stations 20 are displayed. For example, the control unit 142 may cause the navigation device 13 to display the charging station 20 where a charging abnormality is presumed to occur by using a color different from a color that is used for displaying the other charging stations 20. For example, the control unit 142 may control the navigation device 13 such that the navigation device 13 displays the charging station 20 where a charging abnormality is presumed to occur by using a dashed line and displays each of the other charging stations 20 by using a solid line.

In the above description, the case in which the control unit 142 causes the navigation device 13 to display the result of the search for the charging stations 20 has been described. However, indication of the result of the search for the charging stations 20 is not limited to the above-described case. For example, the control unit 142 may cause a display device that is different from the navigation device 13 to display the result of the search for the charging stations 20. For example, the control unit 142 may indicate to the driver of the vehicle 10 the result of the search for the charging stations 20 by audio output.

In addition, in the above description, the case has been described in which the server 30 acquires the abnormality information, the vehicle information, and the charging tool information such that they are associated with each other and searches for the charging stations 20 on the basis of the abnormality information, the vehicle information, and the charging tool information. However, it is not necessary for the server 30 to use the charging tool information in the search for the charging stations 20. In other words, the server 30 may acquire at least the abnormality information and the vehicle information such that they are associated with each other and may search for the charging stations 20 on the basis of at least the abnormality information and the vehicle information.

As described above, the server 30 acquires the abnormality information, which is information relating to a charging abnormality in the charging station 20 where charging of the battery 12 of the vehicle 10 is performed, and the vehicle information, which is information relating to the vehicle 10, such that they are associated with each other and searches for the charging stations 20 on the basis of the abnormality information and the vehicle information. This enables the server 30 to search for the charging stations 20 after determining the charging station 20 and the vehicle 10 where a charging abnormality has occurred in the past. Thus, a search for the charging stations 20 can be conducted by taking into consideration the possibility that a charging abnormality will occur during charging of the battery 12 of the vehicle 10, which requests the search for the charging stations 20, in each of the charging stations 20. The driver of the vehicle 10 can select the charging station 20 by using a result of the search for the charging stations 20 conducted in the manner described above. Therefore, the occurrence of charging abnormalities in the charging stations 20 can be suppressed.

In the above description, examples of the processes executed in the charging system 1 have been described with reference to the sequence diagram illustrated in FIG. 5 and the sequence diagram illustrated in FIG. 6. However, the processes executed in the charging system 1 are not limited to the above-described examples.

For example, in the above-described example, when a charging abnormality does not occur in the charging station 20 during charging of the battery 12, information indicating that no charging abnormality has occurred is transmitted as the abnormality information to the server 30 in step S103 of FIG. 5. However, when a charging abnormality does not occur in the charging station 20 during charging of the battery 12, the transmission of information from the control device 22 of the charging station 20 to the server 30 may not necessarily be performed.

In addition, for example, in step S101 and step S103 of FIG. 5 in the above-described example, the vehicle information relating to the software used in the vehicle 10 for charging is transmitted. However, the transmission of the vehicle information relating to the software used in the vehicle 10 for charging may be performed only when the software has been updated. Along with the transmission of the vehicle information relating to the software used in the vehicle 10 for charging, information that indicates the date and time of the update of the software may be transmitted.

In addition, for example, in step S103 of FIG. 5 in the above-described example, the charging tool information relating to the software used in the charging station 20 for charging is transmitted. However, the transmission of the charging tool information relating to the software used in the charging station 20 for charging may be performed only when the software has been updated. Along with the transmission of the charging tool information relating to the software used in the charging station 20 for charging, information that indicates the date and time of the update of the software may be transmitted.

For example, in step S104 of FIG. 5 in the above-described example, the server 30 stores the vehicle information, the abnormality information, and the charging tool information received thereby in the storage unit 303. In other words, the information transmitted from the control device 22 of the charging station 20 is sequentially accumulated in the storage unit 303. However, the server 30 may delete information that has previously been acquired from the storage unit 303 depending on the situation. For example, in the charging station 20 where a charging abnormality has occurred in the past during charging of the battery 12 of the vehicle 10 that corresponds to the vehicle information of the target vehicle, if charging of the battery 12 of the target vehicle is performed properly, the server 30 may delete information indicating that the charging abnormality has occurred in the past and information associated with the information from the storage unit 303 and may overwrite them with information that indicates a result of the charging of the target vehicle this time. In addition, for example, in the charging station 20 where no charging abnormality has occurred in the past during charging of the battery 12 of the vehicle 10 that corresponds to the vehicle information of the target vehicle, if charging of the battery 12 of the target vehicle is not performed properly and a charging abnormality occurs, the server 30 may delete information indicating that no charging abnormality has occurred in the past and information associated with the information from the storage unit 303 and may overwrite them with information that indicates a result of the charging of the target vehicle this time.

### <Effect of Charging System>

Next, effects of the charging system 1 according to the embodiment of the disclosure will be described.

In the server 30 of the charging system 1 according to the present embodiment, the one or more processors 30a execute a process including acquiring the abnormality information, which is information relating to a charging abnormality in the charging station 20 where charging of the battery 12 of the vehicle 10 is performed, and the vehicle information, which is information relating to the vehicle 10, such that they are associated with each other and searching for the charging stations 20 on the basis of the abnormality information and the vehicle information. This enables the server 30 to search for the charging stations 20 after determining the charging station 20 and the vehicle 10 where a charging abnormality has occurred in the past. Therefore, the search for the charging stations 20 can be performed by taking into consideration the possibility that a charging abnormality will occur during charging of the battery 12 of the vehicle 10, which requests the search for the charging stations 20, in each of the charging stations 20. The driver of the vehicle 10 can select the charging station 20 by using a result of the search for the charging stations 20 conducted in the manner described above. Therefore, the occurrence of charging abnormalities in the charging stations 20 can be suppressed.

In addition, in the server 30 of the charging system 1 according to the present embodiment, it is preferable that the vehicle information include information relating to the type of the vehicle 10. This enables the server 30 to search for the charging stations 20 after determining the charging station 20 where a charging abnormality has occurred in the past and the type of the vehicle 10 for which the charging abnormality has occurred. Therefore, the possibility that a charging abnormality will occur during charging of the battery 12 of the vehicle 10, which requests the search for the charging stations 20, in each of the charging stations 20 can be more appropriately considered.

In addition, in the server 30 of the charging system 1 according to the present embodiment, it is preferable that the vehicle information include information relating to the battery 12. This enables the server 30 to search for the charging stations 20 after determining the charging station 20 where a charging abnormality has occurred in the past and the type of the battery 12 included in the vehicle 10 for which the charging abnormality has occurred. Therefore, the possibility that a charging abnormality will occur during charging of the battery 12 of the vehicle 10, which requests the search for the charging stations 20, in each of the charging stations 20 can be more appropriately considered.

In the server 30 of the charging system 1 according to the present embodiment, it is preferable that the vehicle information include information relating to the software used in the vehicle 10 for charging. This enables the server 30 to search for the charging stations 20 after determining the charging station 20 where a charging abnormality has occurred in the past and the software used in the vehicle 10 with which the charging abnormality has occurred. Therefore, the possibility that a charging abnormality will occur during charging of the battery 12 of the vehicle 10, which requests the search for the charging stations 20, in each of the charging stations 20 can be more appropriately considered.

In the server 30 of the charging system 1 according to the present embodiment, it is preferable that the one or more processors 30a execute a process including acquiring the charging tool information, which is information relating to a charging tool used in the charging station 20 for charging, such that the charging tool information is associated with the abnormality information and the vehicle information and searching for the charging stations 20 on the basis of the charging tool information in addition to the abnormality information and the vehicle information. This enables the server 30 to search for the charging stations 20 after determining the charging station 20 and the vehicle 10 where a charging abnormality has occurred in the past and also determining the charging tool used during the occurrence of the charging abnormality. Therefore, the possibility that a charging abnormality will occur during charging of the battery 12 of the vehicle 10, which requests the search for the charging stations 20, in each of the charging stations 20 can be more appropriately considered.

In the server 30 of the charging system 1 according to the present embodiment, it is preferable that the charging tool information include information relating to the software used in the charging station 20 for charging. This enables the server 30 to search for the charging stations 20 after determining the software used as a charging tool in the charging station 20 where a charging abnormality has occurred in the past and the vehicle 10 for which the charging abnormality has occurred. Therefore, the possibility that a charging abnormality will occur during charging of the battery 12 of the vehicle 10, which requests the search for the charging stations 20, in each of the charging stations 20 can be more appropriately considered.

In the server 30 of the charging system 1 according to the present embodiment, it is preferable that the charging tool information include information relating to a device used in the charging station 20 for charging. This enables the server 30 to search for the charging stations 20 after determining the device used as a charging tool in the charging station 20 where a charging abnormality has occurred in the past and the vehicle 10 for which the charging abnormality has occurred. Therefore, the possibility that a charging abnormality will occur during charging of the battery 12 of the vehicle 10, which requests the search for the charging stations 20, in each of the charging stations 20 can be more appropriately considered.

In the server 30 of the charging system 1 according to the present embodiment, it is preferable that the abnormality information include information indicating the occurrence or nonoccurrence of a charging abnormality. This enables the server 30 to search for the charging stations 20 after appropriately determining the charging station 20 and the vehicle 10 where a charging abnormality has occurred in the past. Therefore, the possibility that a charging abnormality will occur during charging of the battery 12 of the vehicle 10, which requests the search for the charging stations 20, in each of the charging stations 20 can be more appropriately considered.

In the server 30 of the charging system 1 according to the present embodiment, it is preferable that the abnormality information include information indicating the contents of a charging abnormality. This enables the server 30 to search for the charging stations 20 after determining the charging station 20 and the vehicle 10 where a charging abnormality has occurred in the past and also determining the contents of the charging abnormality occurred in the past. Therefore, the possibility that a charging abnormality will occur during charging of the battery 12 of the vehicle 10, which requests the search for the charging stations 20, in each of the charging stations 20 can be more appropriately considered.

In addition, in the control device 14 of the charging system 1 according to the present embodiment, the one or more processors 14a execute a process including indicating a result of a search for the charging stations 20 conducted on the basis of the abnormality information, which is information relating to a charging abnormality in the charging station 20 where the battery 12 of the vehicle 10 is charged, and the vehicle information, which is information relating to the vehicle 10 and which is associated with the abnormality information. As a result, the driver of the vehicle 10 can select the charging station 20 after determining the charging station 20 and the vehicle 10 where a charging abnormality has occurred in the past and by using the result of the search for the charging stations 20 conducted by taking into consideration the possibility that a charging abnormality will occur during charging of the battery 12 of the vehicle 10, which requests the search for the charging stations 20, in each of the charging stations 20. Therefore, the occurrence of charging abnormalities in the charging stations 20 can be suppressed.

Although a preferred embodiment of the disclosure has been described above with reference to the accompanying drawings, it is obvious that the disclosure is not limited to the above-described embodiment and that various modifications or corrections within the scope described in the claims also belong to the technical scope of the disclosure.

For example, in the above description, the process executed by the control device 14, the process executed by the control device 22, and the process executed by the server 30 have been described in such a manner as to be distinguished from each other. However, the devices that execute the above-described processes may be suitably changed. For example, any part of the process described above as the process executed by the control device 14 may be executed by the control device 22 or the server 30. Any part of the process described above as the process executed by the control device 22 may be executed by the control device 14 or the server 30. Any part of the process described above as the process executed by the server 30 may be executed by the control device 14 or the control device 22.

For example, the processes described with reference to the sequence diagrams in the present specification may not necessarily be performed in the order illustrated in the sequence diagrams. In addition, additional processing steps may be employed, and some processing steps may be omitted.

According to the disclosure, occurrence of a charging abnormality in a charging station can be suppressed.

1. A processing apparatus comprising:
one or more processors; and
one or more memories coupled to the one or more processors,
wherein the one or more processors are configured to execute a process comprising
acquiring abnormality information that is information relating to a charging abnormality in a charging station where charging of a battery of a vehicle is performed and vehicle information that is information relating to the vehicle in such a manner that the abnormality information and the vehicle information are associated with each other,
sequentially accumulating the abnormality information and the vehicle information, which are acquired, in the one or more memories, in such a manner that the abnormality information and the vehicle information are associated with each other, and
searching for the charging station based on the abnormality information and the vehicle information that have been previously acquired and accumulated.

2. The processing apparatus according to claim 1,
wherein the vehicle information comprises information relating to a type of the vehicle.

3. The processing apparatus according to claim 1,
wherein the vehicle information comprises information relating to the battery.

4. The processing apparatus according to claim 1,
wherein the vehicle information comprises information relating to software used in the vehicle for the charging.

5. The processing apparatus according to claim 1,
wherein the one or more processors are configured to further execute a process comprising
acquiring charging tool information that is information relating to a charging tool used in the charging station for the charging in such a manner that the charging tool information is associated with the abnormality information and the vehicle information, and
searching for the charging station based on the charging tool information in addition to the abnormality information and the vehicle information.

6. The processing apparatus according to claim 5,
wherein the charging tool information comprises information relating to software used in the charging station for the charging.

7. The processing apparatus according to claim 5,
wherein the charging tool information comprises information relating to a device used in the charging station for the charging.

8. The processing apparatus according to claim 1,
wherein the abnormality information comprises information indicating occurrence or nonoccurrence of the charging abnormality.

9. The processing apparatus according to claim 2,
wherein the abnormality information comprises information indicating occurrence or nonoccurrence of the charging abnormality.

10. The processing apparatus according to claim 3,
wherein the abnormality information comprises information indicating occurrence or nonoccurrence of the charging abnormality.

11. The processing apparatus according to claim 4,
wherein the abnormality information comprises information indicating occurrence or nonoccurrence of the charging abnormality.

12. The processing apparatus according to claim 5,
wherein the abnormality information comprises information indicating occurrence or nonoccurrence of the charging abnormality.

13. The processing apparatus according to claim 6,
wherein the abnormality information comprises information indicating occurrence or nonoccurrence of the charging abnormality.

14. The processing apparatus according to claim 1,
wherein the abnormality information comprises information indicating a content of the charging abnormality.

15. The processing apparatus according to claim 2,
wherein the abnormality information comprises information indicating a content of the charging abnormality.

16. The processing apparatus according to claim 3,
wherein the abnormality information comprises information indicating a content of the charging abnormality.

17. The processing apparatus according to claim 4,
wherein the abnormality information comprises information indicating a content of the charging abnormality.

18. The processing apparatus according to claim 5,
wherein the abnormality information comprises information indicating a content of the charging abnormality.

19. The processing apparatus according to claim 6,
wherein the abnormality information comprises information indicating a content of the charging abnormality.

20. A control device comprising:
one or more processors; and
one or more memories coupled to the one or more processors,
wherein the one or more processors are configured to execute a process comprising
indicating a result of a search for a charging station conducted based on abnormality information that is information relating to a charging abnormality in the charging station where charging of a battery of a vehicle is performed and that has been previously acquired and accumulated and vehicle information that is information relating to the vehicle and that has been previously acquired and accumulated in such a manner as to be associated with the abnormality information.
